(19) United States
(12) Patent Application Publication
(10) Pub. No.: US 2015/0264976 A1
(43) Pub. Date: Sep. 24, 2015

(54) Stopper for Cleaning a Water Pipe and Related Methods

(71) Applicant: Grady Benson, San Diego, CA (US)

(72) Inventor: Grady Benson, San Diego, CA (US)

(21) Appl. No.: 14/217,963

(22) Filed: Mar. 18, 2014

(51) Int. Cl. A24F 9/12; A24F 1/30; B08B 9/032

(52) U.S. Cl. CPC A24F 9/12; B08B 9/032; A24F 1/30

(57) ABSTRACT

The present invention is a stopper that is capable of fitting into both the mouthpiece and the carb hole of a water pipe. The stopper is used to assist with cleaning a water pipe. When the stoppers are placed over the openings, a water pipe can be shaken vigorously without the cleaning solution leaking or spilling. Also disclosed is a method for cleaning a water pipe using the stoppers.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

The following relates to cleaning glassware, specifically to the cleaning of a water pipe.

2. Background of the Invention

Over time resin can build up in a water pipe. The build-up of resin in a water pipe affects the quality of smoke. Therefore, it is important to clean a water pipe on a regular basis. The most effective method of cleaning a water pipe is to rinse a water pipe with hot water, and then add a solution of salt and rubbing alcohol. Once the rubbing alcohol and salt solution has been added to the water pipe, the water pipe needs to be shaken vigorously in order to loosen the resin. Vigorously shaking up a water pipe is the best method of effectively cleaning it. However, vigorously shaking the water pipe has problems. Mainly, there are two openings in a water pipe—the carb and the mouthpiece. When a water pipe containing a cleaning solution is vigorously shaken, some of the liquid will inevitably escape out one of the openings. When shaking the water pipe, it is possible for one to use their hand to plug one of the openings, but this is problematic. When one hand is shaking the water pipe and one hand is plugging the opening, only one hand is shaking the water pipe, meaning that the water pipe is being shaken less vigorously than it would be if two hands were shaking the water pipe. Second, only one opening is being plugged, so cleaning solution can still escape out the other opening. Third, rubbing alcohol is abrasive to skin, so using one's hand to plug the opening can potentially be irritating and uncomfortable. Lastly, shaking the water pipe with one hand, while plugging the carb hole with the other hand, is awkward and difficult to maintain. It would a much simpler process if the water pipe could be shaken with one hand without worrying about cleaning liquid spilling out the openings. Another suggested approach for plugging an opening while cleaning a water pipe was to use plastic wrap and a rubber band to close the opening. Using Plastic wrap and a rubber band is cumbersome and it will not form an effective seal.

There are some products that can be used for plugging the carb of a water pipe. For example, G-Spot Glass makes rubber stoppers similar to corks that can go into the carb hole. The stoppers are available in varying sizes and are not adaptable for to a carb hole of a different size. Furthermore, there is no cork or stopper currently available to fit the mouth piece of a water pipe.

There are several products that can plug openings. Most of the of the stoppers are specifically tailored to fit with wine bottles. U.S. Pat. No. 773,345 to Scheidt, U.S. Pat. No. 1,065,211 to Brook, U.S. Pat. No. 4,483,451 to Gorsky all disclose various types of bottle stoppers for wine bottles. Chinese patent No. 203047731 discloses a bottle stopper that is slanted and able to fit in a variety of different sized openings. These stoppers are made to fit into wine bottles and may not be compatible with water pipes. U.S. Pat. No. 4,108,152 to Kahler discloses a water pipe with caps over both openings. The caps fit over the outside of the openings. The problem with this set up is that the caps cannot be modified to fit various sized openings.

There also have been several modifications to the traditional water pipe to prevent water from spilling out of various openings. U.S. Pat. No. 4,170,237 to Epstien discloses a device that fits into the mouthpiece of a water pipe that allows prevents the water pipe from spilling if it is accidentally tipped over, while still allowing smoke to pass through the mouth piece. While this may be a temporary fix if a water pipe is accidentally knocked over, it is unlikely that this device will prevent water from escaping out the mouth hole if the water pipe is shaken vigorously. U.S. Pat. No. 4,241,741 to Cabados also discloses a water pipe that is spill proof using a series of chambers. This set up may be useful for preventing spills but is limiting when it comes to vigorously shaking a water pipe.

There are also several stopper devices in the field of chemistry laboratory glassware products. U.S. Pat. No. 4,304,425 discloses a series of rubber stoppers for chemistry glassware where there are a plurality of nested stoppers. The stoppers have a hole in the middle so that tubes, pipes, thermometers, etc, can be inserted into through the stoppers and into the glassware. These are useful in the context of laboratory glassware, but the hole in the middle of the stopper makes it impractical for use in the context of cleaning a water pipe.

Thus there is a need for a device that can plug the openings of a water pipe and form a water tight seal that can withstand being vigorously shaken. There also exists a need for a stopper that is versatile enough that it can fit into multiple sized openings. There is also a need for a set of stoppers to fit over both the carb hole and the mouthpiece.

### SUMMARY OF THE INVENTION

Accordingly, it is an object of the present application to stoppers for water pipes that will from a watertight seal over both the mouthpiece and the carb hole that will maintain a firm seal while the water pipe is being vigorously shaken.

It is a further object of the present application to provide a stopper capable of fitting into a variety of sizes of openings.

It is a further object of the present invention to provide stoppers capable of being used with ash catchers and hookahs.

It is a further object of the present invention to create a means for cleaning a water pipe using one hand without the risk of cleaning solution spilling from one of the openings.

Disclosed is a stopper that contains one large stopper and one smaller stopper nested inside of the larger stopper. The stopper is a graduated shape so that it can fit into multiple sized openings. The smaller nested stopper is designed to fit into the carb hole in a water pipe. The larger stopper is designed to fit into the mouth piece of a water pipe.

Other objectives of the invention will become apparent to those skilled in the art once the invention has been shown and described. The manner in which these objectives and other desirable characteristics can be obtained is explained in the following description and attached figures in which:

### BRIEF DESCRIPTION OF THE FIGURES

FIG. 1 is a front view of a water pipe.

FIG. 2 is a perspective view of the larger stopper.

FIG. 3 is a perspective view of the large stopper and the smaller stopper nested inside of the larger cork.

FIG. 4 depicts an interior view of the nested stoppers.

FIG. 5 depicts an interior view of the nested stoppers.

FIG. 6 depicts an environmental view of the stoppers in the water pipe.

FIG. 7 is a perspective view of the larger stopper.

FIG. 8 is a perspective view of the smaller stopper.

### DETAILED DESCRIPTION OF PREFERRED EMBODIMENTS

### Overview

In general, the present application is suitably a series of nested stoppers, with a graduated shape so that they can fit into multiple openings. Generally disclosed is a device for stopping an opening of a water pipe comprising: a first stopper with a solid base so that the stopper is capable of forming a water tight seal with the mouthpiece of a water pipe; and, a second stopper that is smaller than the first stopper; wherein the second stopper is nested inside of the first stopper. Generally disclosed is a method of cleaning a water pipe comprising: pouring a cleaning solution into the water pipe; plugging the mouthpiece with a first stopper; plugging the carb hole with a second stopper that is capable of nesting inside of the first stopper; shaking the water pipe; and, removing the first and second stoppers from the mouthpiece and the carb hole.

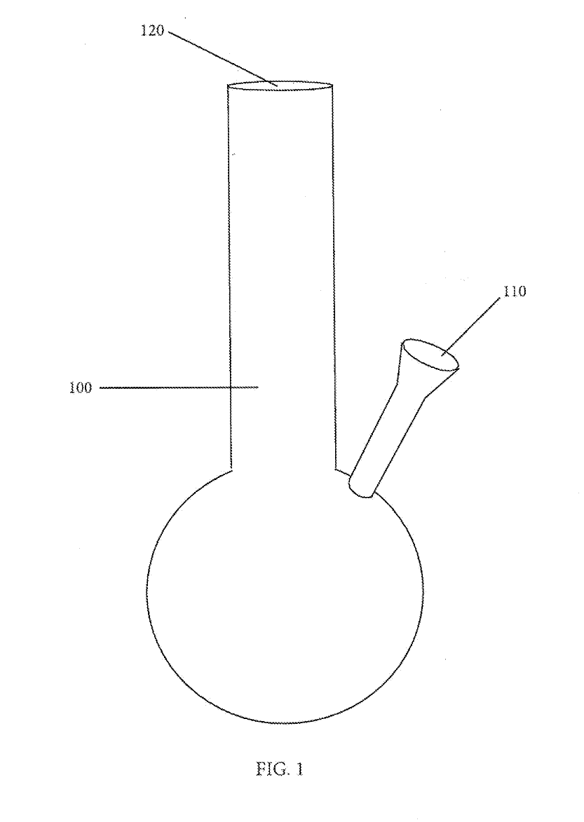

FIG. 1 shows a basic water pipe 100. The water pipe 100 has two openings, the carb hole 110 and the mouthpiece 120.

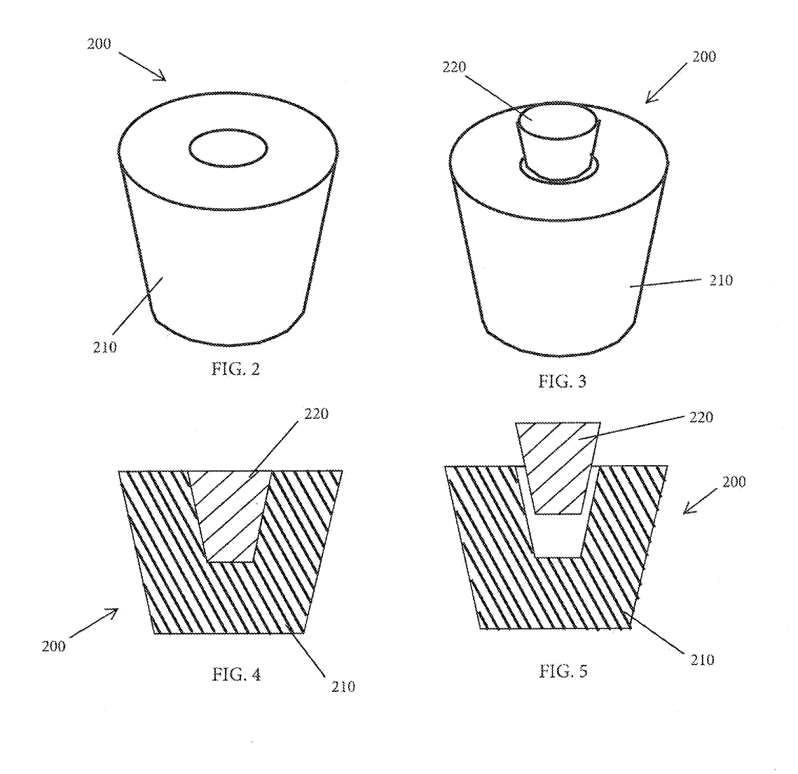

FIG. 2 and FIG. 3 depict the stopper unit 200. The stopper features a large mouthpiece stopper 210. Nested inside of the mouthpiece stopper 210 is the smaller carb hole stopper 220. The stopper unit 200 features two nested stoppers 210, 220 in order for easy storage of both the mouthpiece stopper 210 and the carb hole stopper 220. The nested design allows the stoppers 210, 220 to be kept together so they are easy to find when needed so a user does not have to hunt around for one of the stoppers. In one embodiment (not shown), the mouthpiece stopper 210 and the carb hole stopper 220 may be attached by means of a chain, a string, an elastic piece or equivalent means of attachment. In order so that the smaller carb hole stopper 220 is able to nest inside of the larger mouthpiece stopper 210, the stoppers 210, 220 preferably are the same shape and have the same height-width ratios.

Both the mouthpiece and the carb hole stoppers 210, 220 are shaped like a slated cylinder. The stoppers 210, 220 are slanted in order to accommodate a variety of sizes of openings. For example if a water pipe 100 features a smaller mouthpiece 120, the bottom of the mouthpiece stopper 210 will fit snuggly into the mouthpiece 120. If the water pipe 100 features a larger mouthpiece the top of the mouthpiece stopper 210 will fit snugly into the mouthpiece 120.

The stopper unit 200 is suitably made of rubber, cork, foam, or a sturdy waterproof material that is capable of forming a water tight seal over the two openings 110, 120 of a water pipe 100. In the preferred embodiment, both the mouthpiece stopper 210 and the cat hole stopper 220 are constructed from the same material.

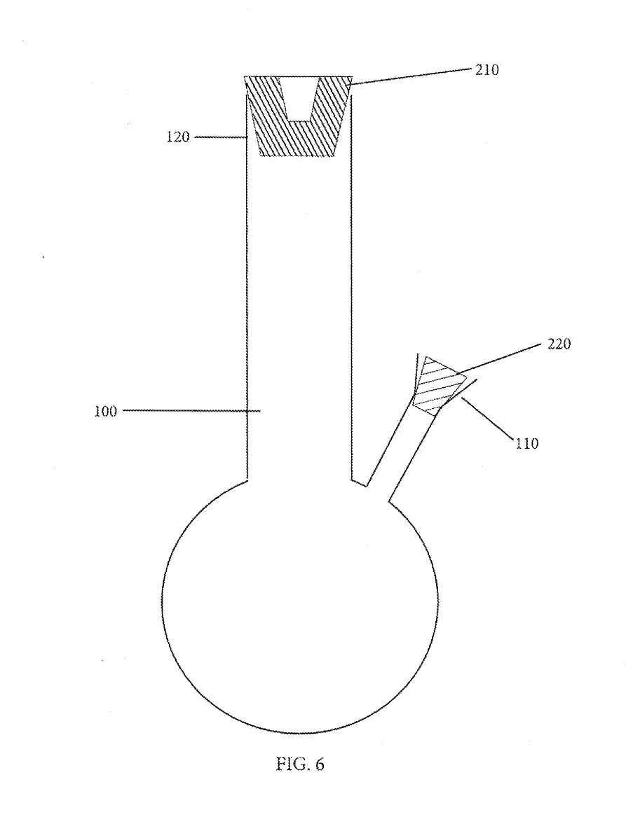

FIGS. 4 and 5 both show an interior view of the stopper unit 200. FIG. 4 shows the carb hole stopper 220 nested inside of the mouthpiece stopper 210. The base of both the mouthpiece stopper 210 and the carb hole stopper 220 are both solid.

FIG. 6 depicts an environmental view of the stoppers 210, 220 in use. The mouthpiece stopper 210 is inserted into the mouthpiece 120 of the water pipe 100. As depicted in FIG. 6, the mouthpiece 120 is relatively large. The mouth piece stopper 210 is depressed into the mouthpiece 120 almost in its entirety, so that very little of the mouthpiece stopper 210 is above the edge of the mouthpiece 120. The carb hole stopper 220 is inserted inside of the carb hole 110. As depicted in FIG. 6, the carb hole 110 is relatively small, so that the bottom of carb hole stopper 220 fits snugly inside of the carb hole 110 and most of the carb hole stopper 220 is above the edge of the carb hole 110.

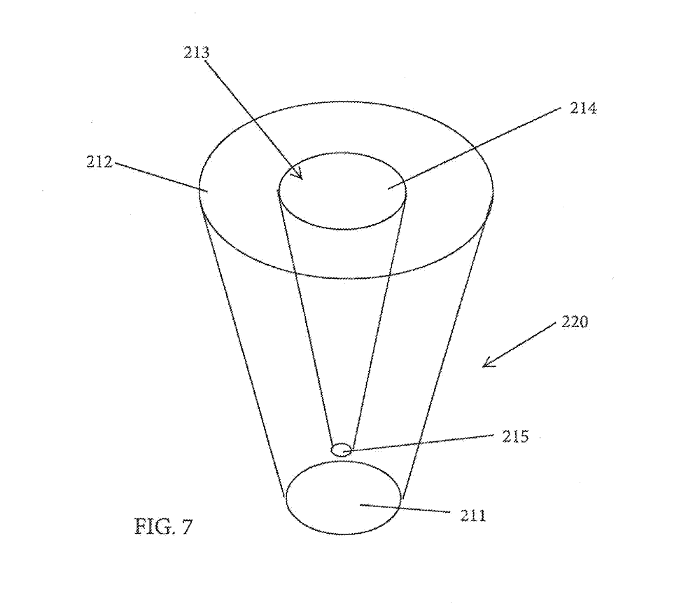

FIG. 7 is a perspective view of the mouthpiece stopper 210 drawn to the approximate scale of the preferred dimensions. Preferably, the base 211 of the mouthpiece stopper 210 has a ten millimeter radius. The radius of the top 212 is preferably twenty five millimeters. The height between the base 211 and the top 212 is preferably sixty-five millimeters. In the center of the mouthpiece stopper 210 is a nest 213 for the smaller stopper 220. The top 214 of the nest 213 preferably has a radius of 10.55 millimeters. The base 215 of the nest 213 is preferably has a radius of 1.5 millimeters. The height between the top 214 and the base 215 of the nest 213 is preferably fifty-five millimeters. The larger stopper 210 may be versatile enough that it incapable of stopping both the mouth piece 120 and the Garb hole 110. In an alternate embodiment (not shown) mouthpiece stoppers 210 does not have a second stopper nested in it. A water pipe 100 can be plugged with two of the mouthpiece stoppers 210 with the disclosed dimensions.

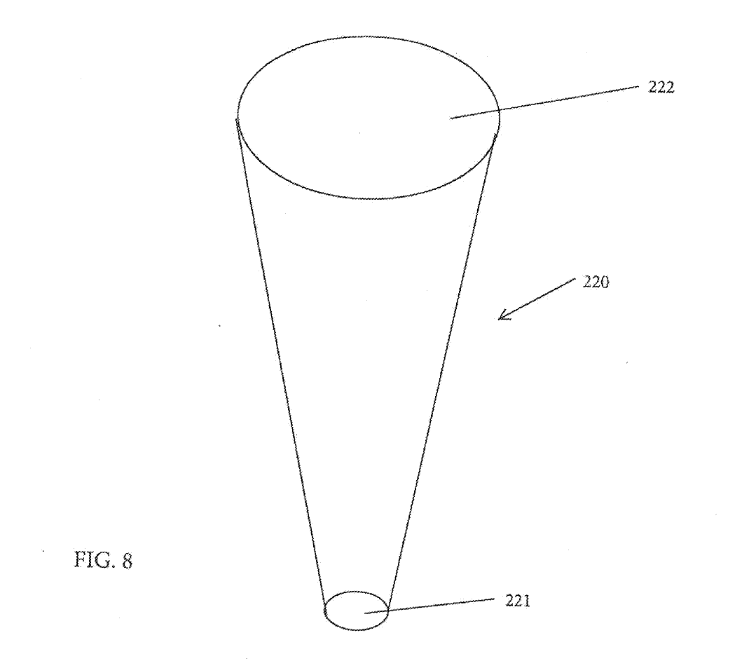

FIG. 8 is a perspective view of the carb hole stopper 220 drawn to the approximate scale of the preferred dimensions. Preferably the base 221 of the carb hole stopper 220 has a two millimeter radius. The radius of the top 222 is preferably 10.5 millimeters. The height between the base 221 and the top 222 is preferably fifty millimeters.

It is to be noted that appended drawings illustrate only typical embodiments of this invention, are not to scale, and therefore not to be considered limiting of its scope, for the invention may admit to other equally effective embodiments which are appreciated by those skilled in the arts.

All features disclosed in this specification, including any accompanying claims, abstract, and drawing, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step of” in the clause as specified in 35 U.S.C. §112, paragraph 6 may not be intended as means plus claim.

1. A device for stopping an opening of a water pipe comprising:
a first stopper with a solid base so that the stopper is capable of forming a water tight seal with the mouthpiece of a water pipe; and,
a second stopper that is smaller than the first stopper;
wherein the second stopper is nested inside of the first stopper.

2. A device according to claim 1 wherein the first and second stoppers are a slanted cylindrical shape.

3. A device according to claim 1 wherein the first and second stoppers are attached by means of attachment selected from the group of a chain, a string, an elastic band.

4. A device according to claim 1 that is capable of being used with ash catchers.

5. A device according to claim 1 that is capable of being used with hookahs.

6. A device according to claim 2 wherein the first and second stoppers are made from rubber.

7. A device according to claim 2 wherein the large stopper has a base with a radius of about 10 mm, a top with a radius of about 25 mm, and a height of about 65 mm.

8. A device according to claim 5 wherein the smaller stopper has a has a base with a radius of about 2 mm, a top with a radius of about 10.5 mm, and a height of about 50 mm.

9. A device according to claim 6 wherein the larger stopper has a nested area with a base with a radius of about 1.5 mm, a top with a radius of about 10.55 mm, and a height of about 55 mm.

10. A method of cleaning a water pipe comprising:
pouring a cleaning solution into the water pipe;
plugging the mouthpiece with a first stopper;
plugging the carb hole with a second stopper that is capable of nesting inside of the first stopper;
shaking the water pipe; and,
removing the first and second stoppers from the mouthpiece and the carb hole.

11. A method of cleaning a water pipe according to claim 10 wherein the cleaning solution is a salt and alcohol mixture.

12. A method of cleaning a water pipe according to claim 10 wherein the cleaning solution is a commercially available water pipe cleaning solution.

13. A method of cleaning a water pipe according to claim 10 wherein the water pipe is shaken with one hand.

14. A method of cleaning a water pipe according to claim 10 wherein the first stopper has a base with a radius of about 10 mm, a top with a radius of about 25 mm, and a height of about 65 mm and the second stopper has a base with a radius of about 2 mm, a top with a radius of about 10.5 mm, and a height of about 50 mm.

15. A method of cleaning a water pipe according to claim 14 wherein the larger stopper has a nested area with a base with a radius of about 1.5 mm, a top with a radius of about 10.55 mm, and a height of about 55 mm.

16. A method of cleaning a water pipe according to claim 15 wherein the water pipe is shaken with one hand.

17. A method of cleaning a water pipe according to claim 10 wherein the water pipe is a hookah pipe.

18. A method of cleaning a water pipe according to claim 10 further comprising the step of cleaning an ash catcher.

19. A method of cleaning a water pipe according to claim 18 further comprising the steps of:
pouring a cleaning solution into the ash catcher;
plugging a first hole of the ash catcher with a first stopper;
plugging a second hole of the ash catcher with a second stopper that is capable of nesting inside of the first stopper;
shaking the ash catcher; and,
removing the first and second stoppers from the holes.

20. A system of stoppers for stopping openings of a water pipe, said system comprising:
a first stopper wherein the first stopper has a base with a radius of about 10 mm, a top with a radius of about 25 mm, and a height of about 65 mm; and,
a second stopper wherein the second stopper has a base with a radius of about 2 mm, a top with a radius of about 10.5 mm, and a height of about 50 mm.
